(19) United States
(12) Patent Application Publication
(10) Pub. No.: US 2026/0312706 A1
(43) Pub. Date: Oct. 8, 2026

(54) METHODS AND APPARATUSES RELATING TO POWER DELAY PROFILES

(71) Applicant: Nokia Technologies Oy, Espoo (FI)

(72) Inventors: Oana-Elena BARBU, Aalborg (DK); Dick CARRILLO MELGAREJO, Espoo (FI)

(21) Appl. No.: 19/481,692

(22) PCT Filed: Apr. 10, 2024
(86) PCT No.: PCT/EP2024/059703

§ 371 Date: Nov. 5, 2025

(30) Foreign Application Priority Data
May 12, 2023 (GB) 2307111.1

(51) Int. Cl. H04B 17/364; H04B 17/27

(52) U.S. Cl. CPC H04B 17/364; H04B 17/27

(57) ABSTRACT

This specification describes a terminal device comprising: means for receiving from a network node, information indicative of a power granularity at which power measurements of power delay profiles shall be reported; means for determining a power delay profile, PDP, based on measurements of a reference signal; means for determining, for a plurality of time delay bins associated with the determined PDP, indices indicative of quantized power measurements for the respective time delay bins, wherein the indices are determined based on (i) power measurements determined for the respective time delay bins based on the determined PDP, (ii) the information indicative of the power granularity, and (iii) a pre-defined rule for determining the indices; and means for sending, to the network node, the indices determined for the plurality of time delay bins.

### FIELD

The present specification relates to power delay profiles in mobile communication systems.

### BACKGROUND

The use of reference signals in mobile communication systems is known. Terminal devices may detect such signals and determine power delay profiles, which give an intensity or power of a signal (e.g. in dBm) received through a multipath channel as a function of propagation delay. These power delay profiles may have many uses, not least in determining the delay spread of a channel. They may also be used for terminal device localisation.

### SUMMARY

In a first aspect this specification describes a terminal device comprising: means for receiving from a network node, information indicative of a power granularity at which power measurements of power delay profiles shall be reported; means for determining a power delay profile, PDP, based on measurements of a reference signal; means for determining, for a plurality of time delay bins associated with the determined PDP, indices indicative of quantized power measurements for the respective time delay bins, wherein the indices are determined based on (i) power measurements determined for the respective time delay bins based on the determined PDP, (ii) the information indicative of the power granularity, and (iii) a pre-defined rule for determining the indices; and means for sending, to the network node, the indices determined for the plurality of time delay bins. The information indicative of the power granularity may be indicative of at least one of the following: a number, M, of possible quantization levels into which power measurements determined for the time delay bins can be quantized; and a quantization parameter, B, based on which power measurements determined for the time delay bins are quantized.

The pre-defined rule may be such that the respective indices are indicative of magnitudes of the respective power measurements determined for the time delay bins relative to a reference power. The pre-defined rule may indicate that the index for each time delay bin for which the determined power measurement is above a sensitivity threshold, Pn, shall be determined based on the information indicative of the power granularity, and a ratio involving the determined power measurement for the time delay bin and the reference power. The terminal device may further comprise means for receiving a sensitivity threshold, Pn, from the network node. The pre-defined rule may indicate that, when the power measurement determined for one of the time delay bins is less than the sensitivity threshold, Pn, the index for that time delay bin is set to a default value or is not reported. The reference power may for instance be one of: a lowest of the power measurements determined for the time delay bins that exceeds the sensitivity threshold, Pn; and a highest of the power measurements determined for the time delay bins.

The terminal device may further comprise means for receiving, from the network node, an indication of the pre-defined rule for determining the indices.

The terminal device may further comprise means for receiving, from the network node, information indicative of a time granularity at which power measurements of power delay profiles shall be reported. The information indicative of the time granularity may be indicative of at least one of the following: a sampling resolution, Ts; and a number of time delay bins for which respective indices shall be determined.

In a second aspect, this specification describes a network node comprising: means for providing, for provision to a terminal device, information indicative of a power granularity at which the terminal device shall report power measurements of power delay profiles; means for receiving a quantized power delay profile, PDP, determined by the terminal device using the information indicative of the power granularity, and based on measurements of a reference signal, the quantized PDP comprising respective indices for a plurality of time delay bins, the respective indices being indicative of quantized power measurements for the time delay bins; and means for determining a location of the terminal device based on the quantized PDP. The information indicative of the power granularity may be indicative of at least one of the following: a number, M, of possible quantization levels into which power measurements determined for the time delay bins can be quantized; and a quantization parameter, B, based on which power measurements determined for the time delay bins are quantized.

The network node may comprise means for determining the information indicative of the power granularity based on at least one of the following: an application for which the determined location of the terminal device is used; a coarse location of the terminal device; and an estimated or previously measured channel path loss.

The network node may comprise means for providing, for provision to the terminal device, a pre-defined rule indicating how the terminal device shall determine the quantized PDP.

The network node may comprise means for providing, for provision to the terminal device, a sensitivity threshold, Pn, for use by the terminal device when determining the quantized PDP.

The network node may comprise means for providing, for provision to the terminal device, information indicative of a time granularity at which power measurements of power delay profiles shall be reported. The information indicative of the time granularity maybe indicative of at least one of the following: a sampling resolution, Ts; and a number of time delay bins for which respective indices shall be determined.

The network node may comprise means for determining the information indicative of the time granularity based on at least one of the following: an environment of the terminal device; a bandwidth of the reference signal; oversampling capabilities of the terminal device; and an expected or previously measured delay spread or a maximum delay spread.

The network node may be a Radio Access Network, RAN, node or a network node that hosts a Location and Management Function, LMF.

In a third aspect, this specification describes a method comprising: receiving, at a terminal device and from a network node, information indicative of a power granularity at which power measurements of power delay profiles shall be reported; determining, by the terminal device, a power delay profile, PDP, based on measurements of a reference signal; determining, by the terminal device and for a plurality of time delay bins associated with the determined PDP, indices indicative of quantized power measurements for the respective time delay bins, wherein the indices are determined based on (i) power measurements determined for the respective time delay bins based on the determined PDP, (ii) the information indicative of the power granularity, and (iii) a pre-defined rule for determining the indices; and sending, by the terminal device and to the network node, the indices determined for the plurality of time delay bins. The information indicative of the power granularity may be indicative of at least one of the following: a number, M, of possible quantization levels into which power measurements determined for the time delay bins can be quantized; and a quantization parameter, B, based on which power measurements determined for the time delay bins are quantized.

The pre-defined rule may be such that the respective indices are indicative of magnitudes of the respective power measurements determined for the time delay bins relative to a reference power. The pre-defined rule may indicate that the index for each time delay bin for which the determined power measurement is above a sensitivity threshold, Pn, shall be determined based on the information indicative of the power granularity, and a ratio involving the determined power measurement for the time delay bin and the reference power. The method may further comprise receiving, by the terminal device, a sensitivity threshold, Pn, from the network node. The pre-defined rule may indicate that, when the power measurement determined for one of the time delay bins is less than the sensitivity threshold, Pn, the index for that time delay bin is set to a default value or is not reported. The reference power may for instance be one of: a lowest of the power measurements determined for the time delay bins that exceeds the sensitivity threshold, Pn; and a highest of the power measurements determined for the time delay bins.

The method may further comprise receiving, by the terminal device and from the network node, an indication of the pre-defined rule for determining the indices.

The method may further comprise receiving, by the terminal device and from the network node, information indicative of a time granularity at which power measurements of power delay profiles shall be reported. The information indicative of the time granularity may be indicative of at least one of the following: a sampling resolution, Ts; and a number of time delay bins for which respective indices shall be determined.

In a fourth aspect, this specification describes a method comprising providing, by a network node and for provision to a terminal device, information indicative of a power granularity at which the terminal device shall report power measurements of power delay profiles; receiving, by the network node, a quantized power delay profile, PDP, determined by the terminal device using the information indicative of the power granularity, and based on measurements of a reference signal, the quantized PDP comprising respective indices for a plurality of time delay bins, the respective indices being indicative of quantized power measurements for the time delay bins; and determining, by the network node, a location of the terminal device based on the quantized PDP. The information indicative of the power granularity may be indicative of at least one of the following: a number, M, of possible quantization levels into which power measurements determined for the time delay bins can be quantized; and a quantization parameter, B, based on which power measurements determined for the time delay bins are quantized.

The method may further comprise determining by the network node the information indicative of the power granularity based on at least one of the following: an application for which the determined location of the terminal device is used; a coarse location of the terminal device; and an estimated or previously measured channel path loss.

The method may further comprise providing, by the network node and for provision to the terminal device, a pre-defined rule indicating how the terminal device shall determine the quantized PDP.

The method may further comprise providing, by the network node and for provision to the terminal device, a sensitivity threshold, Pn, for use by the terminal device when determining the quantized PDP.

The method may further comprise providing, by the network node and for provision to the terminal device, information indicative of a time granularity at which power measurements of power delay profiles shall be reported. The information indicative of the time granularity maybe indicative of at least one of the following: a sampling resolution, Ts; and a number of time delay bins for which respective indices shall be determined.

The method may further comprise determining, by the network node, the information indicative of the time granularity based on at least one of the following: an environment of the terminal device; a bandwidth of the reference signal; oversampling capabilities of the terminal device; and an expected or previously measured delay spread or a maximum delay spread.

The network node may be a Radio Access Network, RAN, node or a network node that hosts a Location and Management Function, LMF.

In a fifth aspect, this specification describes apparatus (e.g. a terminal device or a component of a terminal device) comprising at least one processor and at least one memory storing instructions that, when executed by the at least one processor, cause the apparatus at least to: receive, from a network node, information indicative of a power granularity at which power measurements of power delay profiles shall be reported; determine a power delay profile, PDP, based on measurements of a reference signal; determine, for a plurality of time delay bins associated with the determined PDP, indices indicative of quantized power measurements for the respective time delay bins, wherein the indices are determined based on (i) power measurements determined for the respective time delay bins based on the determined PDP, (ii) the information indicative of the power granularity, and (iii) a pre-defined rule for determining the indices; and send, to the network node, the indices determined for the plurality of time delay bins. The information indicative of the power granularity may be indicative of at least one of the following: a number, M, of possible quantization levels into which power measurements determined for the time delay bins can be quantized; and a quantization parameter, B, based on which power measurements determined for the time delay bins are quantized.

The pre-defined rule may be such that the respective indices are indicative of magnitudes of the respective power measurements determined for the time delay bins relative to a reference power. The pre-defined rule may indicate that the index for each time delay bin for which the determined power measurement is above a sensitivity threshold, Pn, shall be determined based on the information indicative of the power granularity, and a ratio involving the determined power measurement for the time delay bin and the reference power. The instructions may, when executed by the at least one processor, cause the apparatus to receive a sensitivity threshold, Pn, from the network node. The pre-defined rule may indicate that, when the power measurement determined for one of the time delay bins is less than the sensitivity threshold, Pn, the index for that time delay bin is set to a default value or is not reported. The reference power may for instance be one of: a lowest of the power measurements determined for the time delay bins that exceeds the sensitivity threshold, Pn; and a highest of the power measurements determined for the time delay bins.

The instructions may, when executed by the at least one processor, cause the apparatus to receive, from the network node, information indicative of a time granularity at which power measurements of power delay profiles shall be reported. The information indicative of the time granularity may be indicative of at least one of the following: a sampling resolution, Ts; and a number of time delay bins for which respective indices shall be determined.

The instructions may, when executed by the at least one processor, cause the apparatus to receive, from the network node, an indication of the pre-defined rule for determining the indices.

In a sixth aspect, this specification describes apparatus (e.g. a network node or a component of a network node, where the network node may be a Radio Access Network, RAN, node or a network node that hosts a Location and Management Function, LMF) comprising at least one processor and at least one memory storing instructions that, when executed by the at least one processor, cause the apparatus at least to: provide, for provision to a terminal device, information indicative of a power granularity at which the terminal device shall report power measurements of power delay profiles; receive a quantized power delay profile, PDP, determined by the terminal device using the information indicative of the power granularity, and based on measurements of a reference signal, the quantized PDP comprising respective indices for a plurality of time delay bins, the respective indices being indicative of quantized power measurements for the time delay bins; and determine a location of the terminal device based on the quantized PDP. The information indicative of the power granularity may be indicative of at least one of the following: a number, M, of possible quantization levels into which power measurements determined for the time delay bins can be quantized; and a quantization parameter, B, based on which power measurements determined for the time delay bins are quantized.

The instructions may, when executed by the at least one processor, cause the apparatus to determine the information indicative of the power granularity based on at least one of the following: an application for which the determined location of the terminal device is used; a coarse location of the terminal device; and an estimated or previously measured channel path loss.

The instructions may, when executed by the at least one processor, cause the apparatus to provide, for provision to the terminal device, a pre-defined rule indicating how the terminal device shall determine the quantized PDP.

The instructions may, when executed by the at least one processor, cause the apparatus to provide, for provision to the terminal device, a sensitivity threshold, Pn, for use by the terminal device when determining the quantized PDP.

The instructions may, when executed by the at least one processor, cause the apparatus to provide, for provision to the terminal device, information indicative of a time granularity at which power measurements of power delay profiles shall be reported. The information indicative of the time granularity maybe indicative of at least one of the following: a sampling resolution, Ts; and a number of time delay bins for which respective indices shall be determined.

The instructions may, when executed by the at least one processor, cause the apparatus to determine the information indicative of the time granularity based on at least one of the following: an environment of the terminal device; a bandwidth of the reference signal; oversampling capabilities of the terminal device; and an expected or previously measured delay spread, or a maximum delay spread.

In a seventh aspect, this specification describes a non-transitory computer readable medium comprising program instructions stored thereon for causing performance of any of the operations described with reference to any of the first to sixth aspects.

### BRIEF DESCRIPTION OF THE FIGURES

For better understanding of the present application, reference will now be made by way of example to the accompanying drawings in which:

FIG. 1A illustrates an example context within which the described techniques relating to power delay profiles may be performed;

FIG. 1B is an example of a power delay profile measured for a received reference signal;

FIG. 1C is an example of a quantized power delay profile which may be generated using techniques described herein;

FIG. 2. is a message flow diagram illustrating various operations which may be performed in accordance with techniques described herein;

FIG. 3 is a flowchart illustrating various operations which may be performed by a terminal device in accordance with examples described herein;

FIG. 4 is a flowchart illustrating various operations which may be performed by a network node in accordance with examples described herein;

FIG. 5 is a schematic illustration of an example configuration of a terminal device which may be configured to perform various operations described with reference to FIGS. 1 to 3;

FIG. 6 is a schematic illustration of an example configuration of a network node which may be configured to perform various operations described with reference to FIGS. 1 to 4; and

FIG. 7 is an illustration of a computer-readable medium upon which computer readable code may be stored.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

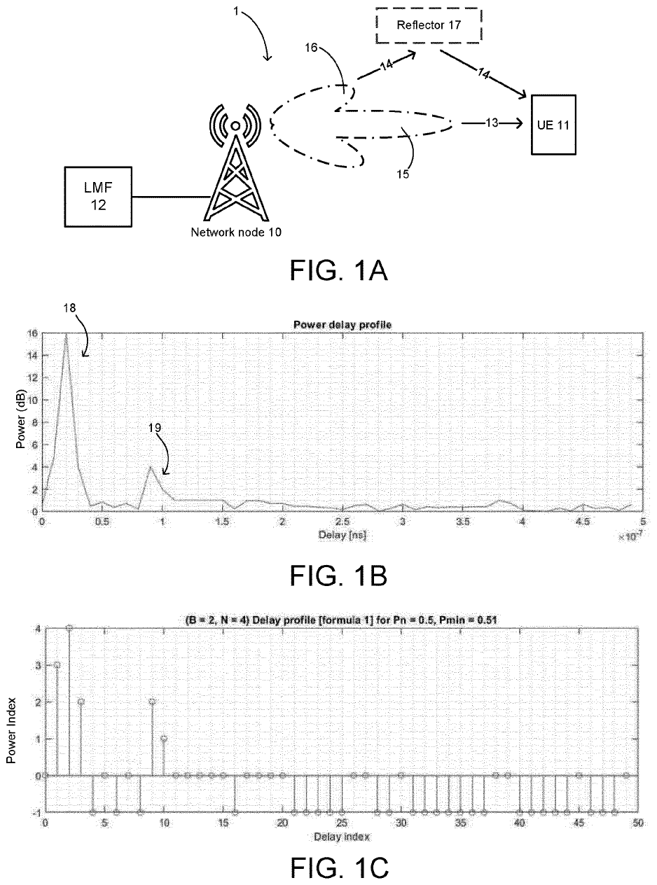

FIG. 1A is a block diagram of an example system, indicated generally by the reference numeral 1, within which techniques described herein may be performed.

The system 1 comprises a network node 10, a terminal device 11, and a location management function (LMF) 12. The LMF 12 may be part of a core network or optionally be part of the radio access network as a location management component (LMC), which may reside at a network node such as a base station. The network node 10 forms part of a mobile communication system and may for example, be a base station, such as a gNB, or some other transmission reception point (TRP). The terminal (or user) device 11 (and other terminal devices described herein) may be a user equipment (UE), a smartphone or some similar device.

The location management function (LMF) 12 seeks to determine the location of the terminal device 11 (and other terminal devices) based, for example, on data received from the terminal device 11 and/or from network nodes, such as the network node 10. That information may include various data, such as one or more of: Downlink Time Difference of Arrival (DL-TDOA); Uplink Time Difference of Arrival (UL-TDOA); Downlink Angle of Departure (DL-AoD); Uplink Angle of Arrival (UL-AoA); and Multi-cell Round Trip Time (Multi-RTT). The LMF 12 may, for example, receive multiple LOS parameters, including LOS probabilities, and use triangulation to estimate user device location(s) based on the most likely LOS signals.

One source of positioning error in legacy mobile communication system positioning methods is the presence of non-line-of-sight (NLOS) and multipath components. That is because, in such legacy methods, only the line-of-sight (LOS) path is measured and exploited for triangulating the UE location. However, when propagation occurs through multiple paths, LOS path identification is not a straightforward task anymore, and it is often the case that another NLOS reflection is misidentified as LOS, for instance due to limited sampling resolution, noise in the system and/or attenuators/obstacles that reduce the LOS path power, etc.

FIG. 1B illustrates an example of a multipath power delay profile that may result from the scenario illustrated in FIG. 1A. The power delay profile may be determined by the terminal device 11 based on measurements of a reference signal, such as a positioning reference signal (PRS) transmitted by network node 10. As illustrated in FIG. 1A, the reference signal transmitted by the network node 10 is received at the terminal device 11 via two paths 13, 14. The first path 13 is the LOS path from the main lobe 15 of the beam via which the reference signal is being transmitted. The second path 14 is a NLOS path from a side lobe 16, which is received at the terminal device 11 via a reflector 17 in the environment.

A first peak 18 on the power delay profile of FIG. 1B corresponds to the first, LOS path, which arrives at the terminal device with the shortest delay and the highest power, since it corresponds to the main lobe. A second peak 19 with a longer delay corresponds to the second path via the reflector. The maximum power of the second peak is significantly lower than that of the first peak. This is at least in part because the second peak corresponds to the side lobe. It will be appreciated that the delay profile illustrated in FIG. 1B is particularly simple and that, in other scenarios, such as when a reference signal is transmitted on multiple beams and/or when there are absorbers and/or additional reflectors in the environment, the power delay profile may have more peaks and some of those peaks may be similar amplitudes/power. In those scenarios, it may be more difficult to identify which peak is the LOS path.

In the 3GPP, there is a general agreement (see. e.g. 3GPP work item RP-213599) that, for instance in AI/ML positioning or AI/ML assisted positioning, it would be beneficial for all significant paths to be measured and exploited to localize a target terminal device. This approach however comes at an additional signalling overhead and latency cost. For instance, reporting complex gain, delay, phase of each detected path for each TRP makes the LPP messages large, and may require both numerous physical layer frequency resources, and time-staggered transmissions.

One proposed approach for reducing the signalling overhead is to report binary delay profiles (DP), instead of the full multipath information. That is, for each time delay bin, report a “1” if a path was detected in the respective time delay bin, and “0” otherwise. However, while this does reduce the signalling overhead, it also removes potentially important information about each path and makes it hard to identify: a) which of the paths is LOS and which is a reflection, and b) which of the paths are dominant and which are negligible or even spurious (e.g. because of reception artifacts, limited bandwidth, etc.).

The techniques described in this specification may enable the reporting to the LMF 12 of quantized power delay profiles, which may allow all significant paths to be exploited when localizing a target terminal device, whilst also limiting signalling overhead. Furthermore, and unlike the binary delay profiles discussed above, techniques described herein do so in such a way that it may be easier to identify: a) which of the paths is LOS and which is a reflection, and b) which of the paths are dominant and which are negligible or spurious. Moreover, the techniques described herein may enable the network to dictate the power granularity (e.g. the number of quantization levels and/or the size of the quantization intervals/steps) with which power measurements are reported.

In particular, the techniques described in this specification may involve the terminal device generating, based on a determined power delay profile (PDP), a quantized PDP which includes a respective index for multiple time delay bins associated with the determined PDP. The indices in the quantized PDP are indicative of quantized power measurements for the respective time delay bins. The indices are determined based on (i) power measurements, Pc, determined for the respective time delay bins based on the determined PDP, (ii) information that is received from a network node (e.g. network node 10 or LMF 12) and is indicative of the power granularity at which power measurements of PDPs shall be reported by the terminal device, and (iii) a pre-defined rule for determining the indices.

As will be appreciated from the below discussion, the information indicative of the power granularity may be indicative of at least one of the following: a number, M, of possible quantization levels into which power measurements, Pc, determined for the time delay bins can be quantized, and a quantization parameter, B, based on which power measurements determined for the time delay bins are quantized. The value(s) of B and/or M may be selectable or tuneable by the network (e.g. the LMF) based on the trade-off between signalling overhead and accuracy/performance. For instance, a first value of B or M, which results in a higher number of quantization levels, and e.g. narrower quantization intervals, may be determined for applications in which high accuracy is required. Conversely, a second value of B or M, which results in a lower number of quantization levels, and e.g. wider quantization intervals, may be determined, for instance, when network conditions dictate a lower signalling overhead and/or for applications in which accuracy is less critical. As also explained in more detail below, the pre-defined rule is such that the respective indices may be indicative of magnitudes of the respective power measurements determined for the time delay bins relative to a reference power measurement. Thus, the indices may convey information regarding the dominant paths, but in a signalling-overhead-efficient manner.

Put in other terms, according to some techniques described herein, terminal devices not only report the time delay bins in which the reference signal is detected, but also report an index (which may also be referred to as a power index) for each time delay bin, which may indicate a magnitude of the power measurements for the time delay bin relative to a reference power measurement. The index may take one of a set of M possible values, with the number of possible values being dependent at least in part on information provided by the network to the terminal device. Put yet another way, terminal devices according to techniques described herein may encode PDP power measurements into one of M quantization levels, where M is tuneable by the network.

An example of a quantized PDP determined based on the PDP of FIG. 1B is shown in FIG. 1C. In the quantized PDP, the power measurements approximated for a plurality of time delay bins (each of which corresponds to a respective one of the delay indexes indicated on the x-axis on FIG. 1C) are encoded as an index, having one of six different values {0, 1, 2, 3, 4} and −1. The precise manner in which this specific quantized PDP was generated is described in more detail below. However, it can be seen that the quantized PDP retains much of the information of the original PDP but, by encoding the power measurements in this manner, the signalling overhead associated with reporting the PDP may be significantly reduced as compared to reporting the original PDP. As will be appreciated, the value −1 in the quantized PDP may not represent a quantized power level as such, but may instead be a default value used when power measurements determined for particular time delay bins are below a minimum threshold, referred to herein as the sensitivity threshold Pn. Thus, it will be appreciated that, although there are six possible index values in the example depicted in FIG. 1C, there are M=5 possible quantized power levels {0, 1, 2, 3, 4}.

The quantized PDP may take the form of a vector, where the index in this vector gives the delay information, and the value at each index gives the power. In other examples, the quantized PDP may be reported as pairs of values where one value corresponds to the delay and the other value corresponds to the power. In such examples, the quantized PDP may be reported as two times 1×X vectors, as X times 1×2 vectors or as one 2×X matrix (or one X×2 matrix), where X is the number of time delay bins for which corresponding power indexes are being reported. In examples in which indexes for determined power values that are below the sensitivity threshold are not reported, X may be less than the number of time delay bins.

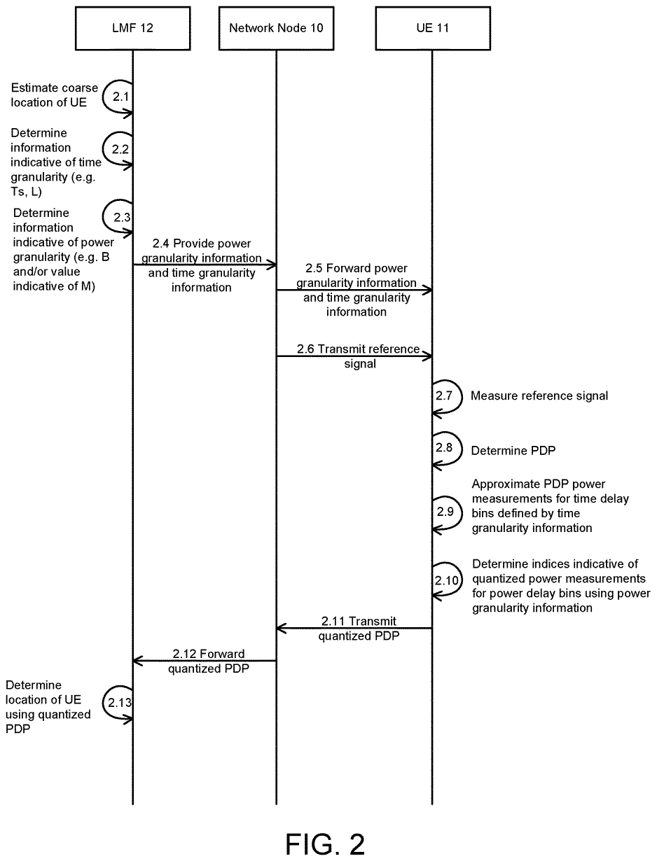

FIG. 2 is a message flow diagram illustrating the techniques described herein according to various examples. The illustrated system shows three different entities: an LMF 12, a network node 10, and a terminal device 11 (referred to in FIG. 2 as UE 11 for brevity). However, as will be appreciated, the functionality described with reference to the LMF 12 (which may itself be referred to as a network node), may in fact be performed at the network node 12, which may for instance be a base station. Put in other terms, the operations described with reference to the LMF 12 may, in some examples, be performed by a network node 10, such as a base station (e.g. a gNB), or alike (e.g. a TRP).

In operation 2.1, the LMF 12 may estimate a coarse location of the terminal device 11. This may be done in any suitable manner, for instance, using one or more of a serving cell ID, a serving beam ID, a previously determined location of the terminal device, handover history, and/or RSRP measurements of the serving and neighbouring cells.

In operation 2.2, based on the estimated location, the LMF 12 may determine information indicative of time granularity at which power measurements of power delay profiles shall be reported. This information indicative of time granularity, which may also be referred to as time granularity information (or even time delay bin information), may, for instance, include a sampling resolution (or binning resolution), Ts, and information indicative of a total number of time delay bins. For instance, this information indicative of the total number of time delay bins may directly indicate a number of bins L to be reported, or may indicate a measurement period over which the PDP was measured and from which the number of bins L may be determined.

For instance, based on the location, delay spread information may be determined. This delay spread information may, for instance, be a measure of the multipath richness of a communications channel. In general, it may be interpreted as a difference between the time of arrival of the earliest significant multipath component (typically the line-of-sight component) and the time of arrival of the a last multipath components. The delay spread information may be an expected delay spread that is expected to be observed by the terminal device when receiving reference signals at the location, a previously measured delay spread at or near the location, or a maximum delay spread. The time granularity information may then be determined based on the delay spread information. For instance, for a larger delay spread, a higher number of bins may be determined, or a sampling resolution may be decreased so that fewer bins cover a longer duration.

As but one example, the LMF 12 may ordinarily set the sampling resolution Ts as equal to Tc, which is the 5N New Radio (NR) time unit. However, for a terminal device that has reported oversampling capabilities, the LMF may set a finer sampling resolution, where Ts equals for instance Tc/m, where m is the oversampling factor reported by terminal device 11. In some examples, the sampling resolution Ts may be constrained by the bandwidth of the reference signal, for instance such that it is at least twice as large as the bandwidth. In other examples, a coarser sampling resolution may be set, e.g. where Ts is greater than Tc, for instance n×Tc, where n is a factor that may be determined by the LMF.

The number of bins L, which corresponds to the measurement period, may for instance be determined in dependence on whether or not the terminal device 11 is estimated to be indoors. For instance, terminal devices 11 that are outdoors may experience fewer reflections than those that are indoors. As such, for a terminal device that is estimated to be indoors, where more reflections (and so paths being received with a greater delay) are expected, the number of bins may be set to a higher value than for a terminal device that is estimated to be outdoors. Similarly, devices operating at the mm-Wave, which may be determinable e.g. based on the serving cell ID, may be assigned a lower number of bins L, given the increased path loss associated with communications in the mm-Wave band. Conversely, devices operating in the C-band or the Low-band may be assigned a higher number bins L. The value of L may however, may be bounded by the cyclic prefix (CP). That is, in such examples, the maximum time delay associated with L may not exceed the duration of the CP. For instance, in one example (e.g. when the terminal device has not reported oversampling capabilities) the number of bins L may be set as equal to [Tcp/Ts], where Tcp is the NR normal cyclic prefix (CP) duration.

In some examples, the time granularity information may not be determined by the LMF, and the terminal device may instead use default values of Ts and L, which may be pre-stored at the terminal device. For instance, the sampling resolution may be set to Tc and L may be set to Tcp/Tc. However, it may be beneficial to adapt Ts and Las described above, e.g. based on the expected conditions at location of the terminal device 11. For instance, by reducing the number of bins L, e.g. by using a lower sampling resolution/higher value of Ts, or by reducing the measurement period, signalling overhead may be reduced. In other examples in which the measurement period is fixed and known to the terminal device, the LMF may determine and provide only the sampling resolution Ts, but not L. Alternatively, the sampling resolution may be fixed and known to the terminal device, in which case only the information indicative of the number of bins L may be determined and provided by the LMF.

In operation 2.3, the information that is indicative of a power granularity at which power measurements of PDPs shall be reported by the terminal device is determined. In some examples, the LMF may determine the quantization parameter B. In other examples, the LMF may determine the value indicative of the number of quantization levels, M. In yet other examples, the LMF may determine both B and the value indicative of the number of quantization levels M.

As will be appreciated, a higher power granularity (e.g. narrower quantization intervals) may be associated with a higher signalling overhead, and potentially also a higher accuracy of location determination. Conversely, a lower power granularity (e.g. wider quantization intervals) may be associated with a lower signalling overhead, but potentially also a lower accuracy of location determination. Thus, the information indicative of the power granularity may be determined based on the currently available signalling overhead and/or an application for which the location of the UE is currently being utilised and related positioning accuracy requirements.

The information indicative of the power granularity may be selected based on the estimated location for the terminal device. For instance, in environments where a greater number of reflections are expected and so there may be greater number of paths experienced by the terminal device, a higher power granularity may be utilised so that it is easier to determine their relative powers. Conversely, where fewer paths are expected (e.g. outdoors or when operating in the mm-wave), and/or the paths are expected to have a large power differential, a lower power granularity may be utilised.

In addition, based on the estimated location, a channel path loss information that is expected/estimated to be observed by the terminal device when receiving reference signals may be determined. This channel path loss information may, for instance, include an expected channel attenuation that is expected to be observed at the terminal device for the LoS component and is somehow indicative of the maximum receive power to be expected for a channel tap. Based on the estimated channel path loss, the information indicative of the power granularity may be determined. For instance, if the channel path loss is high, a higher power granularity may be utilised so as to capture the power of the weakest taps.

As explained above, the information indicative of the power granularity may the quantization parameter B. As will be appreciated from the below discussion, the number quantisation levels into which the power measurements may be quantised by the terminal device 11 may depend at least in part on the value of the quantization parameter B. The value of the quantization parameter B also may define the size(s) of the quantization intervals (uniform or non-uniform sizes).

In some examples, the number of possible quantisation levels M may be determined by the terminal device 11 based on the value of the quantization parameter B indicated by the LMF 12. For instance, the number of possible quantisation levels M may be determined based on B and the power measurement for the time delay bin having the highest power measurement. However, in other examples, for instance when the LMF 12 knows (or can estimate) the highest power measurement, e.g. from a previous iteration or from the determined course location, the LMF 12 may determine the number of quantisation levels M, which may be indicated to terminal device 11 in addition to or instead of the quantization parameter B. For instance, the LMF may indicate a value N which is equal to the highest possible power index that can be utilised by the terminal device. As will become clear from the discussion below, the relationship between the highest possible index, N, and the number of possible quantization levels M may depend on the pre-defined rule that is used for determining the power index.

In some examples, the LMF may additionally determine the pre-defined rule that shall be used by the terminal device 11 to determine the quantised PDP. For instance, the LMF 12 may select from multiple different predefined rules, which may cause the terminal device to determine the power indices in slightly different ways. The selected predefined rule may then be signalled to the terminal device. In other examples, there may be only one predefined rule (e.g. one of the two specific examples described herein). In such examples, the pre-defined rule may be pre-stored at the terminal device.

The pre-defined rule may, for instance, fall into one of two categories: those which define a logarithmic relationship between the index j and the power measurement Pc, and those which define a linear relationship between j and Pc. The pre-defined rule may, regardless of whether the relationship is linear or logarithmic, determine the power index based on a ratio involving a reference power and the respective power measurements determined for the time delay bins. When the LMF selects the pre-defined rule, the selection may e.g. be based on expected channel conditions given an estimated location for the UE. For instance, where there are expected to be a great number of paths with dissimilar power levels, a logarithmic rule may be more appropriate.

A rule falling into the first category may, for instance, indicate that the power index for each time delay bin for which the determined power measurement is above a sensitivity threshold shall be set to a lowest integer value that is above (i.e. using the ceiling function) log (i.e. the logarithm to the base B) of a ratio involving the power measurement determined for the time delay bin and the reference power Pref. Thus, in this example, the quantization parameter B may be determinative of the quantization intervals (although they are not uniform due to the logarithmic relationship).

A predefined rule falling into the second category may however define that the power index for each time delay bin for which the determined power measurement is above a sensitivity threshold shall be set to a lowest integer value that is above (i.e. using the ceiling function) the linear ratio of the power measurement determined for the time delay bin and the power measurement Pref. In such examples, the reference power may be the quantization parameter B, which may also represent the quantisation intervals.

The pre-defined rules may additionally indicate that, when the power measurement determined for one of the time delay bins is less than the sensitivity threshold, Pn, the index for that time delay bin shall be set to a default value. However as explained above, in some other examples, power indices for delay bins for which the power measurement is below the sensitivity threshold may not be reported.

In some examples, the sensitivity threshold, Pn, may be determined by the LMF and signalled to the terminal device 11. For instance, the sensitivity threshold, Pn, may be determined based on a number of different factors, for instance, but not limited to a terminal device reference sensitivity level, expected SINR, etc., In other examples, the sensitivity threshold may be pre-stored or otherwise determined by the terminal device 11.

In some examples, the reference power may be a lowest of the power measurements Pmin determined for the time delay bins that exceeds the sensitivity threshold, Pn. In other examples, the reference power may be same as the sensitivity threshold Pn. That is, the index for any delay bins having a power that is less than the reference power may be set to the default value or may not be reported. In yet other examples, the reference power may be a highest of the power measurements Pmax determined for the time delay bins. In examples in which the power measurements that are above the sensitivity threshold are greater than the reference power (e.g. when the reference power is Pmin or Pn), the ratio utilised in the pre-defined rule may be Pc, which is the power measurement for the time delay bin, divided by Pref. Conversely, when the power measurements are below the reference power (e.g., when Pmax is the reference power), the ratio may be the Pref divided by Pc.

One example of a predefined rule falling into the first category (referred to as the first example predefined rule) is as follows:

$$j = \{ \begin{matrix}⌈ {log}_{B} ( \frac{Pc}{Pref} ) ⌉ , Pc > Pn \\ - 1 , otherwise\end{matrix} , \qquad ( 1 )$$

where j is the determined power index for a given time delay bin, Pn is the sensitivity threshold, B is the quantization parameter, Pc is the power measurement determined for the time delay bin, and Pref is the reference power. As discussed, Pref may be, for instance, the power measurement of the time delay bin having the lowest power measurement Pmin that is above the sensitivity threshold, Pn, or the value of sensitivity threshold Pn itself.

The indices j generated using the first example predefined rule may be from the set {−1, 0, 1, . . . , N}. In examples in which the LMF only indicates B (and not explicit information indicative of M), the highest possible index N may be derived by the terminal device as:

$$N = ⌈ {log}_{B} ( \frac{P max}{Pref} ) ⌉$$

Put another way, N may take the value of the lowest integer value that is above (i.e. using the ceiling function) log_{B} (i.e. the logarithm to the base B) of the ratio Pmax and the reference power. Alternatively, in examples in which the LMF indicates the highest index value N (which is indicative of M, the number of quantization levels), the terminal device may determine the value of the quantization parameter according to:

$$B = ⌈ \sqrt[N]{( \frac{P max}{Pref} )} ⌉$$

In some implementations in which the LMF indicates the value of N, the terminal device may constrain any power indexes j, which according to the predefined rule would exceed N, to N. The network (e.g. the LMF) dictating the number of quantization levels may be beneficial. This is not least because the terminal device typically reports quantized PDPs for reference signals detected from multiple different TRPs. By constraining the UE to report N levels (or N+1 levels) exactly, the quantized PDPs for all TRP may be on the same scale.

As will be appreciated, the first example predefined rule causes the power measurement for the kth time delay bin Pc(k) which has been assigned an index j to be approximated (or quantized) as Pc(k)≈Bⁱ×Pref.

One example of a predefined rule falling into the second category (referred to as the second example predefined rule) is as follows:

$$j = \{ \begin{matrix}⌈ \frac{Pc}{Pref} ⌉ , Pc > Pn \\ 0 , otherwise\end{matrix} , \qquad ( 2 )$$

As noted above, in such a rule, Pref may be the quantization parameter B (and so Pref may be replaced by the quantization parameter, B). Alternatively, it may be the minimum power Pmin above the sensitivity threshold (and B may be used to determine the quantization intervals).

The indices j generated using the second example predefined rule may be from the set {0, 1, . . . , N}. In examples in which the LMF indicates B (=Pref) and not information indicative of the number of quantization levels, the highest possible index N may be derived by the terminal device as:

$$N = ⌈ \frac{P max}{B} ⌉$$

In examples in which the LMF indicates the information indicative of the number of quantization levels (e.g. N) and not the quantization parameter, the value of B (=Pref) may be derived as:

$$B = ⌈ \frac{P max}{N} ⌉$$

It will be appreciated that the second example predefined rule causes the power measurement for the kth time delay bin Pc(k) which has been assigned an index j to be approximated (or quantized) as Pc(k)≈j×B=j×Pref.

Although the predefined rules are discussed above as utilizing a ceiling function, it will be appreciated that they may instead utilize a floor function, or may even set the quantization levels as the midpoint of the respective quantization intervals.

The values of Pc used for determining the power indices j may have any associated unit. For instance, they may be linear or logarithmic (e.g. dB). If the units are linear, a higher value of B or a lower value of N may be indicated by the LMF in order to reduce the number of possible quantization levels

In operation 2.4, the LMF 12 provides, for provision to the terminal device 11, the information indicative of the power granularity at which power measurements of power delay profiles shall be reported. As has been discussed above, the LMF may provide the value of the quantization parameter B and/or a value indicative of the number of quantization levels M. The value indicative of the number of quantization levels, M, may be N which represents the highest power index. The value of N together with the predefined rule may indicate the number of quantization levels. For instance, in rules of the first category, such as the first example predefined rule, M may equal N+1. In rules of the second category, such as the second example predefined rule, M may equal N.

The LMF may additionally provide the time granularity information (e.g. Ts and L) to the terminal device. This may occur for instance if the terminal device is not pre-configured to use e.g. default values of Ts and L. Similarly, in some examples, the sensitivity threshold Pn, and/or the predefined rule for determining the power indices may also be provided by the LMF to the terminal device 11. In some examples and as mentioned above, the terminal device 11 may be configured to use the value of Pn as the reference power, Pref, when applying the pre-defined rule. In such examples and when for instance the second example predefined rule is being used, the value of B may serve as Pn and Pref.

The information provided in operation 2.4., for instance the value of B and/or N and none or any combination of Ts, L, Pn and the pre-defined rule for determining the power indices, may be provided via one or more information element (IE) included within one or more signalling messages or data flows. In some examples, they may all be included in a signal information element included within a single signalling message.

In examples in which the LMF 12 is part of the core network, the information provided in operation 2.4 may be sent to a base station, or other TRP, e.g. network node 10. For instance, the information may arrive at the network node 10 from an access and mobility function. The network node 10 may then forward the information to the terminal device 11 in operation 2.5. Alternatively, if the functionality of the LMF 12 is performed at the network node 10, the information provided in operation 2.4 may be sent directly to the terminal device 11. Either way, the information may then be stored at the terminal device 11 for use in determining quantised PDPs.

Next, the network node 10 may, in operation 2.6, transmits a reference signals, such as a positioning reference signal, PRS.

In operation 2.7, the terminal device 11 measures this reference signal and detects multipath components, including at least their delay and power. Thus, the terminal device may have determined a power delay profile (in operation 2.8) for the reference signal, e.g., as illustrated in FIG. 1B.

Next, in operation 2.9, the terminal device 12 may determine approximate power measurements Pc for each of plural time delay bins, for instance, as defined by the time granularity information. For instance, the terminal device 11 may determine, based on the power measurements, a respective mean power for the durations corresponding to each of the time delay bins. In addition, determining the approximate power measurements may additionally comprise approximating measured delay values to fit the delay bins defined by the time granularity information. For instance, if a measured channel impulse response (having a particular measured power) was detected at a delay of 0.35 ns, but the sampling resolution was 0.2 ns, then the delay may be approximated to the nearest delay bin index, e.g. that representing a delay of 0.4 ns.

In operation 2.10, the terminal device 11 determines, for each of the delay bins and using Pc, the information indicative of the power granularity (e.g. B and/or N), and the pre-defined rule (which may for instance have been indicated by the LMF), a power index indicative of a quantized power measurement for the delay bin. The pre-defined rule applied by the terminal device when determining the power indices may be as discussed above with respect to operation 2.4.

As part of operation 2.10, the terminal device 11 may, in some examples, determine Pmin and/or Pmax. As noted above, the value of N, which is the highest possible index value may be determined based on B and Pmax in dependence on the specific predefined rule that is being used. Pmin or Pmax may be utilised as the reference power against which Pc is compared when generating the indices. Alternatively, Pn may be used as the reference power. In other examples, e.g. when rules falling within the second category are used, the quantization parameter B may define the reference power.

Together, the determined indices may be referred to as a quantized PDP. The quantized PDP may be represented in any suitable way, examples of which have been described herein. For instance, the quantized PDP may be expressed as a grid G with L elements each corresponding to a respective time delay bin. The value of each element is the determined power index j for the respective time bin. In the specific examples described herein, and depending on the specific rule used and whether or not power indices are reported for delay bins having a power below the sensitivity threshold, j may take a value from the set {−1, 0, . . . , N}, from the set {0, 1, . . . , N} or from the set {1, . . . , N}. For instance, the quantized PDP illustrated in FIG. 1C (which was generated using the PDP of FIG. 1B, the first example predefined rule discussed above, a quantization parameter value of B=2, a sampling resolution Ts=32.5 ns, a value of Pn=0.5, a value of Pref=0.51) may be expressed as:

$$[ 0 , 3 , 4 , 2 , - 1 , 0 , - 1 , 0 , - 1 , 2 , 1 , 0 , 0 , 0 , 0 , 0 , - 1 , 0 , 0 , 0 , 0 , - 1 , - 1 , - 1 , - 1 , - 1 , 0 , 0 , - 1 , - 1 , - 0 , - 1 , - 1 , - 1 , - 1 , - 1 , - 1 , - 1 , 0 , 0 , - 1 , - 1 , - 1 , - 1 , 0 , - 1 , - 1 , 1 , 0 ]$$

In operation 2.11, the terminal device 11 reports the quantised PDP determined in operation 2.10 to the network. For instance, it may be sent to the network node 10, which in operation 2.12 may forward it to the LMF.

Subsequently, in operation 2.13, the LMF 12, or some other network entity may use the quantised PDP to determine the location of the terminal device 11. As part of this, the quantized PDP may be decoded. Such decoding may be performed using the values of Ts and B, which are known to the network, and, in some examples, also Pref. For instance, as described above, when the first predefined rule is used, the decoded power for each time delay bin may be determined as Pc(k)~Bⁱ×Pref. In some examples, the LMF may already have knowledge of Pref (for instance, when it is Pn). In other examples, the value of Pref may be indicated to the LMF by the terminal device (e.g. when Pref=Pmin). When the second predefined rule is used, the decoded power for each time delay bin may be determined as Pc(k)≈j×B.

In some examples, the terminal device 11 may additionally be configured to report indexes corresponding to quantized angular information (e.g. angle of departure AoD or angle of arrival AoA) estimations. Angle of departure estimations may, for instance, be obtained during channel estimation. The terminal device may, for each time delay bin, report relative angular information. For instance, the terminal device may approximate all AoD to an angular grid with resolution R=x degrees. The angle associated with time delay bin having the highest power index may be selected as the reference angle. The angular offset relative to the reference tap for the other time delay bins may then be computed. This angular offset may then be reported along with the power indices. For instance, if the resolution is 45 degrees, there may be 8 different angular bins in the angular grid. Each time delay bin may be assigned an angle index from 0 to 7, where 0 indicates that the same angle as the reference angle and 7 indicates that the angle is offset by approximately 315 degrees.

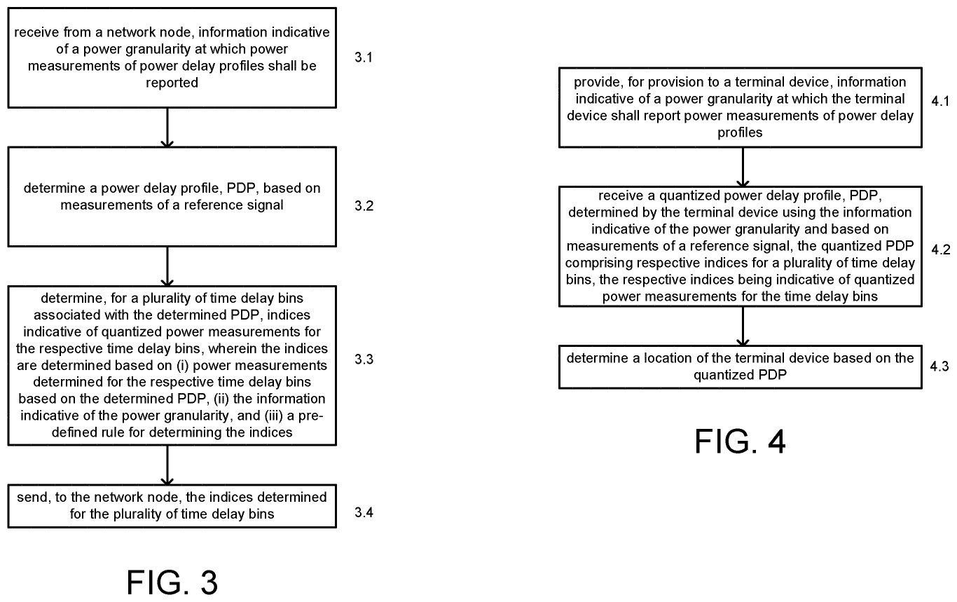

FIG. 3 is a flowchart illustrating operations that may be performed by terminal devices according to techniques described herein. It will be appreciated that the operations depicted in and described with reference to FIG. 3, may be the same as, or at least similar to, operations described with reference to FIG. 2.

In operation, 3.1, the terminal device receives from a network node, information indicative of a power granularity at which power measurements of power delay profiles shall be reported. The information indicative of the power granularity may be indicative of at least one of the following a number, M, of possible quantization levels into which power measurements determined for the time delay bins can be quantized, and a quantization parameter, B, based on which power measurements determined for the time delay bins are quantized.

The information received in operation 3.1 may be similar to that discussed with respect to operation 2.4 of FIG. 2. As such, although not illustrated in FIG. 3, the terminal device may additionally receive, from the network node, any combination of: 1) an indication of the pre-defined rule for determining the power indices, 2) information indicative of the time granularity (e.g. Ts and L) for which the respective power indices shall be determined; and 3) information indicative of a sensitivity threshold Pn.

In operation 3.2, the terminal device determines a power delay profile, PDP, based on measurements of a reference signal. This may be as described with reference to operations 2.7 and 2.8.

In operation 3.3, the terminal device determines, for a plurality of time delay bins associated with the determined PDP, indices (also referred to as power indices) indicative of quantized power measurements for the respective time delay bins, wherein the indices are determined based on (i) power measurements determined for the respective time delay bins based on the determined PDP, (ii) the received information indicative of the power granularity, and (iii) the pre-defined rule for determining the indices. Operation 3.3 may be as described with reference to operation 2.10 of FIG. 2.

The determining of the power measurements for the respective time delay bins based on the determined PDP may be as described with reference to operation 2.9.

The predefined rule may be as described with reference to operation 2.4. For instance, the pre-defined rule may be such that the respective indices are indicative of magnitudes of the respective power measurements determined for the time delay bins relative to a reference power. In some examples, the pre-defined rule may indicate that the index for each time delay bin for which the determined power measurement is above a sensitivity threshold, Pn, shall be determined based on the information indicative of the power granularity, and a ratio involving the determined power measurement for the time delay bin and the reference power. The pre-defined rule may in some examples indicate that, when the power measurement determined for one of the time delay bins is less than the sensitivity threshold, Pn, the index for that time delay bin is set to a default value. Alternatively, when the power for a particular time delay bin is below a sensitivity threshold, the index for such bins may not be reported. In some examples, the reference power measurement may be a lowest of the power measurements determined for the time delay bins that exceeds the sensitivity threshold, Pn. In other examples, the reference power measurement is a highest of the power measurements determined for the time delay bins. In other examples, the reference power may be defined by the quantization parameter B. In other examples, the reference power may be the sensitivity threshold.

In operation 3.4, the terminal device 10 sends, to the network node, the indices determined for the plurality of time delay bins. Collectively the indices may be referred to as a quantized PDP. In some examples, the quantized PDP may be expressed as a vector of values from the set {−1, 0, 1 . . . , N}, where Nis dependent on B and Pmax. Operation 3.4 may correspond with operation 2.11 (and in some examples also operation 2.12).

FIG. 4 is a flowchart illustrating operations that may be performed by network nodes, for instance Radio Access Network (RAN) nodes or network nodes that host a Location and Management Function (LMF), according to techniques described herein. It will be appreciated that the operations depicted in and described with reference to FIG. 3, may be the same as, or at least similar to, operations described with reference to FIG. 2.

In operation 4.1, the network node provides, for provision to a terminal device, information indicative of a power granularity at which the terminal device shall report power measurements of power delay profiles. The information indicative of the power granularity may be indicative of at least one of: a number, M, of possible quantization levels into which power measurements determined for the time delay bins can be quantized, and a quantization parameter, B, based on which power measurements determined for the time delay bins are quantized. As described above, the network node may determine the information indicative of the power granularity based on at least one of the following: an application for which the determined location of the terminal device is used, a coarse location of the terminal device, and an estimated or previously measured channel path loss. The determination of the information indicative of the power granularity may be as described with reference to operation 2.3 of FIG. 2.

In addition to the information indicative of the power granularity, the network node may provide, for provision to the terminal device, at least one of: (1) the pre-defined rule indicating how the terminal device shall determine the quantized PDP; (2) the sensitivity threshold, Pn, for use by the terminal device when determining the quantized PDP, and (3) information indicative of the time granularity for which the respective indices shall be determined.

The information indicative of the time granularity may include a sampling resolution, Ts, and information indicative of a number of time delay bins for which respective indices shall be determined. In examples in which this information is provided to the terminal device, the network node may further determine a coarse location of the terminal device (e.g. as described with reference to operation 2.1 in FIG. 2), and may determine the information indicative of the time granularity based on the coarse location of the terminal device. In addition, the network node may determine the information indicative of the time granularity based on a bandwidth of the reference signal, and/or an estimated/measured/maximum delay spread, and/or oversampling capabilities of the terminal device, and/or based on an environment of the terminal device (indoor vs outdoor). The determination of the time granularity information may be as described with reference to operation 2.2.

In operation 4.2, the network node receives a quantized power delay profile, PDP, determined by the terminal device using the information indicative of the power granularity and based on measurements of a reference signal. The quantized PDP comprises respective indices for a plurality of time delay bins, the respective indices being indicative of quantized power measurements for the time delay bins. This may be as described with reference to FIG. 2, not least operations 2.11 and 2.12.

In operation 4.3, the network node determines a location of the terminal device based on the quantized PDP. This may correspond with operation 2.13 of FIG. 2.

### Example Configurations of Apparatuses

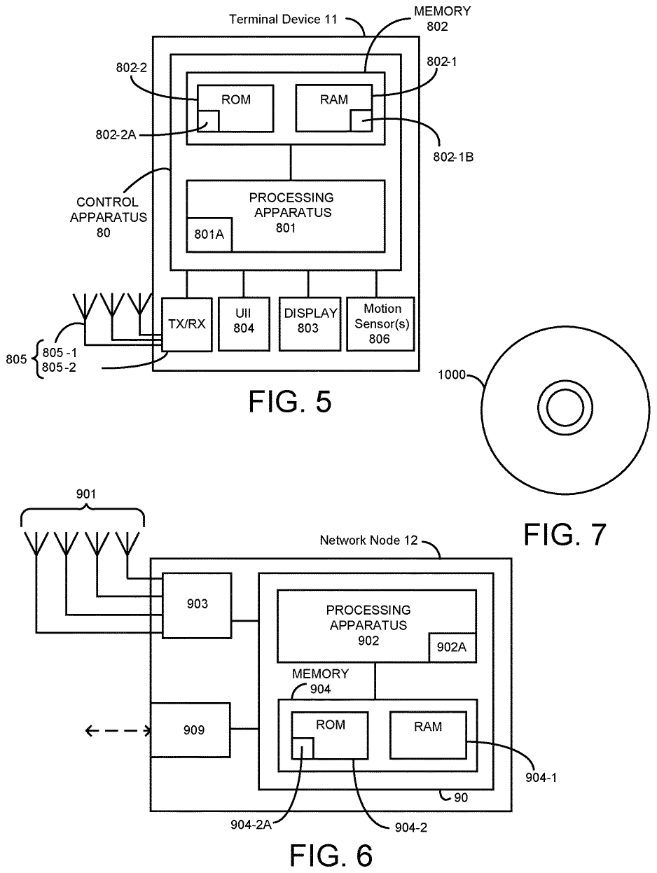

FIG. 5 is a schematic illustration of an example configuration of a terminal device 11 which may be configured to perform various operations described with reference to FIGS. 1 to 3.

The terminal device 11 may communicate, e.g. with a base station, via an appropriate radio interface arrangement 805. The interface arrangement 805 may be provided for example by means of a radio part 805-2 (e.g. a transceiver) and an associated antenna arrangement 805-1. The antenna arrangement 805-1 may be arranged internally or externally to the terminal device 11. In order to be able to utilise beam forming, the antenna arrangement 805-1 includes multiple antennas. For instance, some UE's may include twelve antenna elements, e.g. four panels each having four cross-polarized antenna elements.

The terminal device 11 comprises a controller/control (or processing) apparatus 80 which is operable to control the other components of the terminal device UE in addition to performing any suitable combinations of the operations described in connection with terminal device 11 with reference to the preceding FIGS. The control apparatus 80 may comprise processing apparatus 801 and memory 802. Computer-readable code 802-2A may be stored on the memory 802, which when executed by the processing apparatus 801, causes the control apparatus 80 to perform any of the operations described herein in relation to the terminal device 11.

Example configurations of the memory 802 and processing apparatus 801 will be discussed in more detail below

The terminal device 11 may be, for example, a device that does not need human interaction, such as an entity that is involved in Machine Type Communications (MTC). Alternatively, the terminal device 11 may be a device designed for tasks involving human interaction such as making and receiving phone calls between users and streaming multimedia or providing other digital content to a user. Non-limiting examples for the terminal device 11 include a smart phone, a laptop, a smartwatch, a tablet computer, an e-reader, a vehicle-based terminal device, such as those mounted on cars, buses, uncrewed aerial vehicles (UAVs), aeroplanes, trains, or boats, or any type of terminal device that may be carried by a user, or worn on their person.

Where the terminal device UE is a device designed for human interaction, the user may control the operation of the terminal device 11 by means of a suitable user input interface UII 804 such as keypad, voice commands, touch sensitive screen or pad, combinations thereof or the like. A display 803, a speaker and a microphone may also be provided. Furthermore, the terminal device 11 may comprise appropriate connectors (either wired or wireless) to other devices and/or for connecting external accessories, for example hands-free equipment, thereto. The terminal device 11 may additionally be associated with (e.g., comprises or is in short range wired or wireless communication with) one or a plurality of motion sensors 806 for sensing motion of the mobile device. The terminal device may additionally include other sensors such as a GNSS unit.

FIG. 6 is a schematic illustration of an example configuration of a network node 12. As described above, the network node may be a radio access node or a node with hosts a location management function. In examples, in which the network node 12 is a radio access node, the node may be configured for communicating with the terminal device 11 via a wireless interface. In such examples, the network node may, as depicted in FIG. 6, comprise a radio frequency antenna array 901 configured to receive and transmit radio frequency signals. Although the network node 12 is shown as having an array 901 of four antennas, this is illustrative only. The number of antennas may vary from two to many hundreds. The network node 12 further comprises radio frequency interface circuitry 903 configured to interface between the antenna 901 and a control apparatus 90. The radio frequency interface circuitry 903 may also be known as a transceiver.

The network node also comprises one or more interfaces 909 via which it can communicate (e.g. via X2 messages) with base stations and other network entities such as those of the core network. In examples, in which the network node is a node within the core network, the node may not communicate directly with terminal device and so may omit the RF components. However, the network node may utilise interface(s) 909 to communicate with other core network entities such as the AMF and the like.

The network node control apparatus 90 may be configured to cause the exchange of information with other network elements via the interface 909. In addition, in examples in which the network node is a RAN node, the network node control apparatus 90 may be configured to process signals from the radio frequency interface circuitry 903, control the radio frequency interface circuitry 903 to generate suitable RF signals to communicate information to the terminal devices via the wireless communications link, and also

The network node control apparatus 90 may comprise processing apparatus 902 and memory 904. Computer-readable code 904-2A may be stored on the memory 904, which when executed by the processing apparatus 902, causes the control apparatus 90 to perform any of the operations assigned to the base station TRP1 described above.

As should of course be appreciated, the entities 11, 12 shown in each of FIGS. 5 and 6 described above may comprise further elements which are not directly involved with processes and operations in respect which this application is focused.

Some further details of components and features of the above-described apparatus/entities/apparatuses and alternatives for them will now be described.

The control apparatuses 80, 90 may comprise processing apparatus 801, 902 communicatively coupled with memory 802, 904. The memory 802, 904 has computer readable instructions 802-2A, 904-2A stored thereon, which when executed by the processing apparatus 801, 902 causes the control apparatus 80, 90 to cause performance of various ones of the operations described herein. The control apparatus 80, 90 may in some instances be referred to, in general terms, as “apparatus”.

The processing apparatus 801, 902 may be of any suitable composition and may include one or more processors 801A, 902A of any suitable type or suitable combination of types. For example, the processing apparatus 801, 902 may be a programmable processor that interprets computer program instructions 802-2A, 904-2A and processes data. The processing apparatus 801, 902 may include plural programmable processors. Alternatively, the processing apparatus 801, 902 may be, for example, programmable hardware with embedded firmware. The processing apparatus 801, 902 may be termed processing means. The processing apparatus 801, 902 may alternatively or additionally include one or more Application Specific Integrated Circuits (ASICs). In some instances, processing apparatus 801, 902 may be referred to as computing apparatus.

The processing apparatus 801, 902 is coupled to the memory (which may be referred to as one or more storage devices) 802, 904 and is operable to read/write data to/from the memory 802, 904. The memory 802, 904 may comprise a single memory unit or a plurality of memory units, upon which the computer readable instructions (or code) 802-2A, 904-2A is stored. For example, the memory 802, 904 may comprise both volatile memory 802-1 and non-volatile memory 802-2. For example, the computer readable instructions/program code 802-2A, 904-2A may be stored in the non-volatile memory 802-2, 904-2 and may be executed by the processing apparatus 801, 902 using the volatile memory 802-1, 904-1 for temporary storage of data or data and instructions. In some examples, a transmission buffer 802-1B of the terminal device 11 may be constituted by volatile memory 802-1 of the UE control apparatus 80. Examples of volatile memory include RAM, DRAM, and SDRAM etc. Examples of non-volatile memory include ROM, PROM, EEPROM, flash memory, optical storage, magnetic storage, etc. The memories in general may be referred to as non-transitory computer readable memory media.

The term ‘memory’, in addition to covering memory comprising both non-volatile memory and volatile memory, may also cover one or more volatile memories only, one or more non-volatile memories only, or one or more volatile memories and one or more non-volatile memories.

The computer readable instructions/program code 802-2A, 904-2A may be pre-programmed into the control apparatus 80, 90. Alternatively, the computer readable instructions 802-2A, 904-2A may arrive at the control apparatus 80, 90 via an electromagnetic carrier signal or may be copied from a physical entity 1000 such as a computer program product, a memory device or a record medium such as a CD-ROM or DVD an example of which is illustrated in FIG. 6. The computer readable instructions 802-2A, 904-2A may provide the logic and routines that enables the entities devices/apparatuses to perform the functionality described above. The combination of computer-readable instructions stored on memory (of any of the types described above) may be referred to as a computer program product.

Embodiments of the technology described herein may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing apparatus” etc. should be understood to encompass not only computers having differing architectures such as single/multi-processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

If desired, the different functions discussed herein may be performed in a different order and/or concurrently with each other. Furthermore, if desired, one or more of the above-described functions may be optional or may be combined. Similarly, it will also be appreciated that flow diagrams described herein are examples only and that various operations depicted therein may be omitted, reordered and or combined.

Although the methods and apparatuses have been described in connection with a New Radio (NR) network, it will be appreciated that they are not limited to such networks and are applicable to radio networks of various different types.

Although various aspects of the methods and apparatuses described herein are set out in the independent claims, other aspects may comprise other combinations of features from the described embodiments and/or the dependent claims with the features of the independent claims, and not solely the combinations explicitly set out in the claims.

It is also noted herein that while various examples are described above, these descriptions should not be viewed in a limiting sense. Rather, there are several variations and modifications which may be made without departing from the scope of the present invention as defined in the appended claims.

1-21. (canceled)

22. An apparatus comprising at least one processor and at least one memory storing instructions that, when executed by the at least one processor, cause the apparatus at least to:
receive, from a network node, information indicative of a power granularity at which power measurements of power delay profiles shall be reported;
determine a power delay profile (PDP) based on measurements of a reference signal;
determine, for a plurality of time delay bins associated with the determined PDP, indices indicative of quantized power measurements for the respective time delay bins, wherein the indices are determined based on (i) power measurements determined for the respective time delay bins based on the determined PDP, (ii) the information indicative of the power granularity, and (iii) a pre-defined rule for determining the indices; and
send, to the network node, the indices determined for the plurality of time delay bins.

23. The apparatus of claim 22, wherein the information indicative of the power granularity is indicative of at least one of the following:
a number, M, of possible quantization levels into which power measurements determined for the time delay bins can be quantized; or
a quantization parameter, B, based on which power measurements determined for the time delay bins are quantized.

24. The apparatus of claim 22, wherein the pre-defined rule is such that the respective indices are indicative of magnitudes of the respective power measurements determined for the time delay bins relative to a reference power.

25. The apparatus of claim 24, wherein the pre-defined rule indicates that the index for each time delay bin for which the determined power measurement is above a sensitivity threshold, Pn, shall be determined based on the information indicative of the power granularity, and a ratio involving the determined power measurement for the time delay bin and the reference power.

26. The apparatus of claim 25, wherein the apparatus is further caused to:
receive the sensitivity threshold, Pn, from the network node.

27. The apparatus of claim 26, wherein the pre-defined rule indicates that, when the power measurement determined for one of the time delay bins is less than the sensitivity threshold, Pn, the index for that time delay bin is set to a default value or is not reported.

28. The apparatus of claim 25, wherein the reference power is one of:
a lowest of the power measurements determined for the time delay bins that exceeds the sensitivity threshold, Pn; or
a highest of the power measurements determined for the time delay bins.

29. The apparatus of claim 22, wherein the apparatus is further caused to:
receive, from the network node, an indication of the pre-defined rule for determining the indices.

30. The apparatus of claim 22, wherein the apparatus is further caused to:
receive, from the network node, information indicative of a time granularity at which power measurements of power delay profiles shall be reported.

31. The apparatus of claim 30, wherein the information indicative of the time granularity is indicative of at least one of the following:
a sampling resolution, Ts; or
a number of time delay bins for which respective indices shall be determined.

32. An apparatus comprising at least one processor and at least one memory storing instructions that, when executed by the at least one processor, cause the apparatus at least to:
provide, for provision to a terminal device, information indicative of a power granularity at which the terminal device shall report power measurements of power delay profiles;
receive a quantized power delay profile (PDP) determined by the terminal device using the information indicative of the power granularity, and based on measurements of a reference signal, the quantized PDP comprising respective indices for a plurality of time delay bins, the respective indices being indicative of quantized power measurements for the time delay bins; and
determine a location of the terminal device based on the quantized PDP.

33. The apparatus of claim 32, wherein the information indicative of the power granularity is indicative of at least one of the following:
a number, M, of possible quantization levels into which power measurements determined for the time delay bins can be quantized; or
a quantization parameter, B, based on which power measurements determined for the time delay bins are quantized.

34. The apparatus of claim 32, wherein the apparatus is further caused to:
determine the information indicative of the power granularity based on at least one of the following:
an application for which the determined location of the terminal device is used;
a coarse location of the terminal device; or
an estimated or previously measured channel path loss.

35. The apparatus of claim 32, wherein the apparatus is further caused to:
provide, for provision to the terminal device, a pre-defined rule indicating how the terminal device shall determine the quantized PDP.

36. The apparatus of claim 32, wherein the apparatus is further caused to:
provide, for provision to the terminal device, a sensitivity threshold, Pn, for use by the terminal device when determining the quantized PDP.

37. The apparatus of claim 32, wherein the apparatus is further caused to:
provide, for provision to the terminal device, information indicative of a time granularity at which power measurements of power delay profiles shall be reported.

38. The apparatus of claim 37, wherein the information indicative of the time granularity is indicative of at least one of the following:
a sampling resolution, Ts; or
a number of time delay bins for which respective indices shall be determined.

39. The apparatus of claim 37, wherein the apparatus is further caused to:
determine the information indicative of the time granularity based on at least one of the following:
an environment of the terminal device;
a bandwidth of the reference signal;
oversampling capabilities of the terminal device; or
an expected or previously measured delay spread or a maximum delay spread.

40. The apparatus of claim 32, wherein the apparatus is a Radio Access Network (RAN) node or a network node that hosts a Location and Management Function (LMF).

41. A method comprising, by a terminal device:
receiving, from a network node, information indicative of a power granularity at which power measurements of power delay profiles shall be reported;
determining a power delay profile (PDP) based on measurements of a reference signal;
determining, for a plurality of time delay bins associated with the determined PDP, indices indicative of quantized power measurements for the respective time delay bins, wherein the indices are determined based on (i) power measurements determined for the respective time delay bins based on the determined PDP, (ii) the information indicative of the power granularity, and (iii) a pre-defined rule for determining the indices; and
sending, to the network node, the indices determined for the plurality of time delay bins.
